(19) United States
(12) Patent Application Publication
(10) Pub. No.: US 2025/0033188 A1
(43) Pub. Date: Jan. 30, 2025

(54) SYSTEM AND METHOD FOR LIFTING AND HANDLING MECHANISM FOR CRYOGENIC SPECIMENS

(71) Applicant: Alcor Life Extension Foundation, Scottsdale, AZ (US)

(72) Inventor: Steven Graber, Phoenix, AZ (US)

(73) Assignee: Alcor Life Extension Foundation, Scottsdale, AZ (US)

(21) Appl. No.: 18/358,290

(22) Filed: Jul. 25, 2023

(51) Int. Cl. B25J 1/04; F17C 13/00

(52) U.S. Cl. CPC B25J 1/04; F17C 13/006; F17C 2223/0161; F17C 2270/0509

(57) ABSTRACT

A lifting mechanism for a placement of a cryogenic specimen in a cryogenic storage chamber or Dewar vessel, the lifting mechanism comprising and upper member and a lower member. The upper member may comprise a handle, an upper shaft coupled to the handle at a first end, and a locking mechanism. The lower member may comprise an attachment point and a backboard. The lower member may be coupled at a second end of the upper shaft. The backboard may be coupled to the attachment point by a lower shaft and configured to support the cryogenic specimen.

### BACKGROUND OF THE TECHNOLOGY

Cryonics is a process of preserving human bodies or brains at extremely low temperatures in the hope that future technology will be able to revive them and restore their functions. The goal of cryonics is to prevent irreversible death and preserve the body or brain until medical science advances to the point where it can cure the cause of death and revive the individual. The process involves cooling the body or brain down to a temperature of −196° C. (−320° F.) using liquid nitrogen, which slows down biological processes to the point where they almost stop. The body or brain is then stored in a specially designed cryostat, which maintains the low temperature indefinitely.

It's important to note that cryonics is not the same as cryogenics, which refers to the study of the effects of extremely low temperatures on living organisms. Cryogenics has many scientific applications, such as preserving biological samples for research purposes or storing embryos for fertility treatments.

Cryogenics deals with the production and behavior of materials at extremely low temperatures, usually below −150 degrees Celsius (−238 degrees fahrenheit) and sometimes as low as −273.15 degrees Celsius (−459.67 degrees fahrenheit), which is known as absolute zero. At these temperatures, materials can exhibit unique properties such as superconductivity, where electrical resistance drops to zero, and superfluidity, where liquids flow with no viscosity.

Cryopreserved specimen refers to a biological sample, such as cells, tissues, or organs, that has been preserved at extremely low temperatures using a process called cryopreservation. This process involves cooling the specimen to a very low temperature, usually below −130° C., which effectively halts all biological activity and preserves the sample for future use.

The most common method of cryopreservation involves the use of cryoprotectants, such as glycerol or dimethyl sulfoxide (DMSO), which help to prevent damage to the cells during the freezing and thawing process. Once the specimen has been treated with cryoprotectants, it is gradually cooled to a very low temperature, usually in a specialized freezer or liquid nitrogen storage tank.

Cryopreservation is commonly used in research laboratories and medical settings to store biological samples for long periods of time. Cryopreserved specimens can be stored for many years and then thawed for use in a variety of applications, including cell culture, transplantation, and genetic analysis.

Dewar vessels, also known as Dewar flasks or cryogenic storage containers, are specialized containers used for the storage and transportation of extremely cold liquids, such as liquid nitrogen, oxygen, or helium. Dewar vessels consist of two containers, one nested within the other, with a vacuum-sealed space in between. The inner container is typically made of glass or metal and contains the liquid to be stored or transported. The outer container is usually made of metal and provides structure, supporting and protecting the inner container and preventing infiltration of gasses into the vacuum-sealed space. The vacuum-sealed space is usually partially occupied by alternating layers of aluminized plastic sheeting and fiberglass matting wrapped around the inner container, known as superinsulation, which blocks radiative transfer of heat from the outer container to the inner container.

Dewar vessels are commonly used in scientific research, medical laboratories, and industrial applications. They are designed to keep the contents at extremely low temperatures for extended periods, allowing for long-term storage and transportation of cryogenic materials. Some models of Dewar vessels are also equipped with pressure-relief valves to prevent the build-up of pressure within the container due to evaporation of the stored liquid.

Biostasis refers to the maintenance of living organisms in a state of suspended animation, with a reduced metabolic rate and a slowdown in biological processes, in order to preserve them for an extended period of time. The goal of biostasis is to extend the lifespan of organisms or to keep them alive until they can be restored to full function in the future. Biostasis can be achieved through a variety of methods, including lowering the temperature of an organism, reducing the metabolic rate, or using chemicals to induce a state of suspended animation.

Biostasis has potential applications in a variety of fields, including space exploration, medical science, and cryonics. In medical science, biostasis could be used to preserve organs for transplantation, to buy time for the treatment of traumatic injuries, or to help extend the shelf life of blood and other medical supplies. Cryonics is the practice of freezing human bodies or brains in the hope that they can be revived in the future with advanced medical technology, and biostasis is a key component of this process.

Cryogenic specimens are stored for extended periods of time, including whole cryoprotected human bodies. The Dewar vessels in which specimens are stored are open-top tanks filled with liquid nitrogen which must be loaded vertically from above. Cryogenic specimens are pre-chilled in an external device prior to the transfer to long-term storage, so the procedure must be completed quickly to avoid rewarming of the specimen during the period of exposure to room air. This introduces a challenge in handling specimens which can weigh upwards of 400 lbs in a rapid manner, while also being able to control the point at which they are loaded into the Dewar vessel.

### SUMMARY OF THE TECHNOLOGY

A lifting system and method for maneuvering a cryogenic specimen according to various embodiments of the present technology provides user with the ability to manipulate a cryogenic specimen within a Dewar vessel or other type of cryogenic storage chamber. The system and apparatus includes a lifting mechanism for a placement of a cryogenic specimen in a cryogenic storage chamber or Dewar vessel, the lifting mechanism comprising and upper member and a lower member. The upper member may comprise a handle, an upper shaft coupled to the handle at a first end, and a locking mechanism. The lower member may comprise an attachment point and a backboard. The lower member may be coupled at a second end of the upper shaft. The backboard may be coupled to the attachment point by a lower shaft and configured to support the cryogenic specimen.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures. For simplicity and clarity of illustration, elements in the figures are not necessarily drawn to scale.

FIG. 1 representatively illustrates a perspective view of a lifting mechanism in accordance with an exemplary embodiment of the present technology;

FIG. 2 representatively illustrate a perspective view of a lower member of the lifting mechanism in accordance with an exemplary embodiment of the present technology;

FIG. 3 representatively illustrate a perspective view of an upper member of the lifting mechanism in accordance with an exemplary embodiment of the present technology;

FIG. 4 representatively illustrate a partial, exploded perspective view of the connection between the upper and lower members of the lifting mechanism in accordance with an exemplary embodiment of the present technology;

FIG. 5 representatively illustrate a partial perspective view of the connection between the upper and lower members of the lifting mechanism in the locked position in accordance with an exemplary embodiment of the present technology; and

FIG. 6 representatively illustrates cross section view of FIG. 5 in accordance with an exemplary embodiment of the present technology.

### DETAILED DESCRIPTION OF THE DRAWINGS

The present technology may be described in terms of functional block components and various processing steps. Such functional blocks may be realized by any number of components configured to perform the specified functions and achieve the various results. For example, the present technology may employ various types of rods, levers, handles, plates, shafts, connectors, straps, support members and the like, which may carry out a variety of functions. Further, the present technology may employ any number of components for a lifting mechanism to remove a cryogenic specimen from a Dewar vessel.

Methods and apparatus for a lifting mechanism to maneuver a cryogenic specimen may operate in conjunction with any suitable Dewar vessel or other type of cryogenic storage chamber. Various representative implementations of the present technology may be applied to any system for a lifting mechanism to lift and remove a cryogenic specimen from a Dewar vessel or other type of cryogenic storage chamber. The lifting mechanism enables manipulation of very large cryogenic specimens during transfers between Dewar vessels or other type of cryogenic storage chamber, minimizing risk of human exposure to liquid nitrogen and offering multiple ways to control the position of the cryogenic specimen.

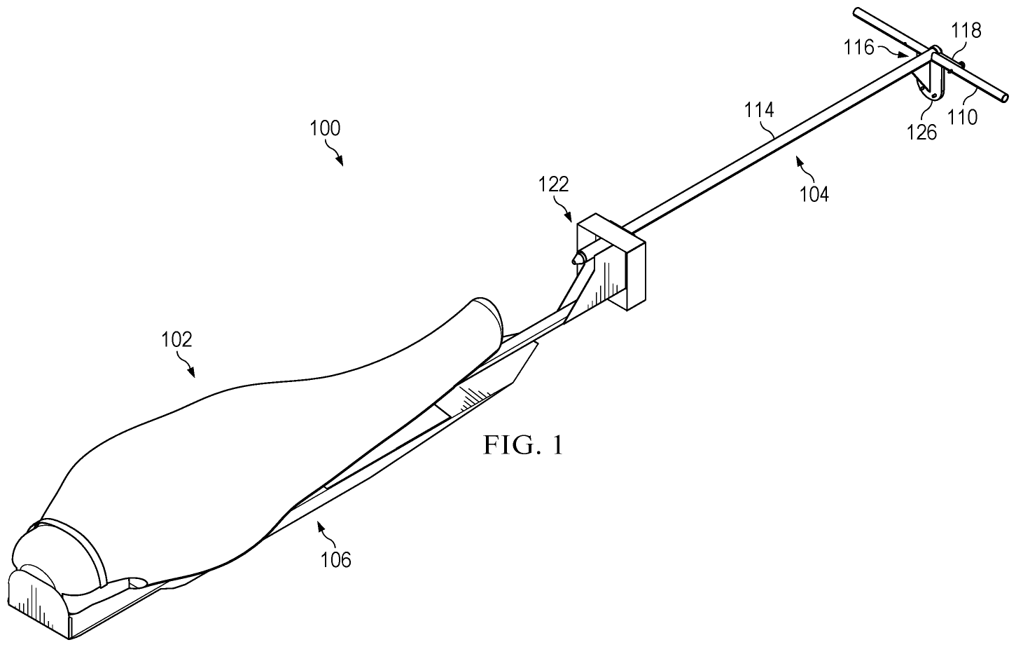

Referring now to FIG. 1, methods and apparatus for a lifting mechanism 100 for a cryogenic specimen 102 is shown. The lifting mechanism 100 may comprise an upper member 104 and a lower member 106.

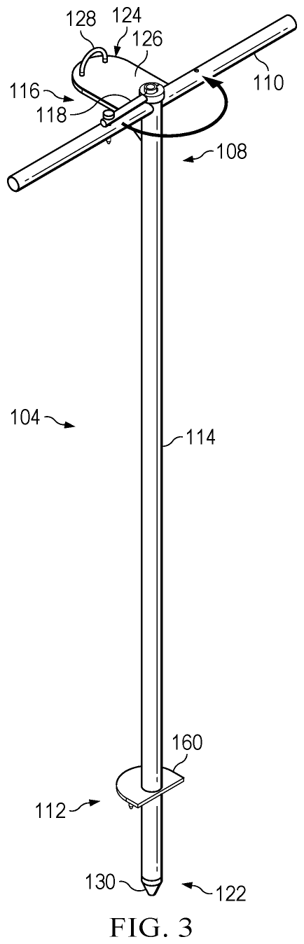

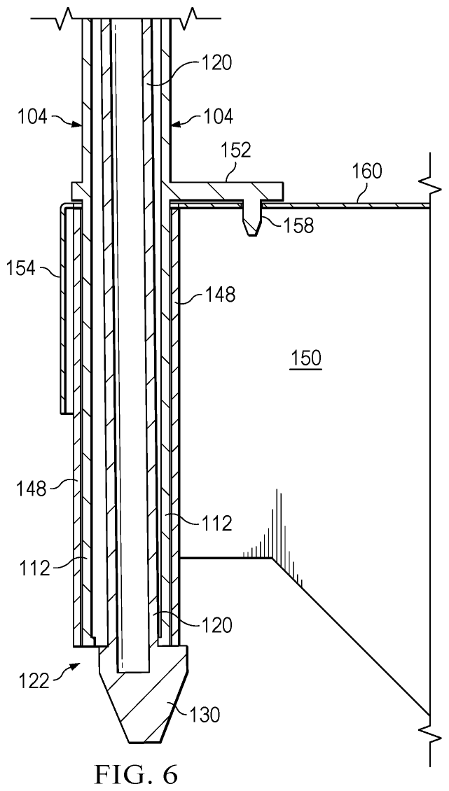

Referring now to FIG. 3, the upper member 104 may comprise a first end 108 having a handle 110, a second end 112 that attaches to the lower member 106, and an upper shaft 114 extending between the first end 108 and the second end 112. The upper member 104 may comprise a locking mechanism 116 comprising a lever 118, an internal rod 120 (FIG. 6), and an eccentric cam lock 122. The upper member 104 may further comprise a hoist point 124, which is configured to allow the user to attach a hoist to remove the lifting mechanism 100, with the cryogenic specimen 102 attached thereto. The hoist point 124 may comprise a plate 126 extending from the handle 110 with an eye bolt 128 that may be connected to a hoist to elevate and transfer the cryogenic specimen 102 to a Dewar vessel or other type of cryogenic storage chamber.

Referring again to FIG. 3, the handle 110 is located at the first end 108 of the upper member 104 and may comprise a pair of arms that extend from a center portion of the handle 110. The handle 110 may comprise any suitable configuration that would allow manipulation of lifting mechanism 100 to maneuver the lifting mechanism 100 within a Dewar vessel or other cryogenic storage chamber. The handle 110 of upper member 104 enables a technician to manually reposition the cryogenic specimen 102 within the Dewar vessel or other cryogenic storage chamber, to maximize available space.

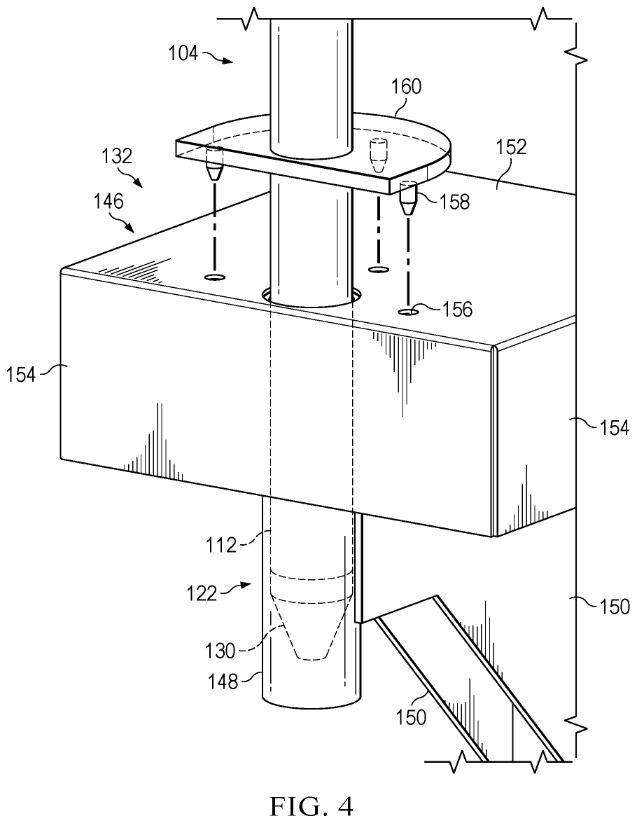

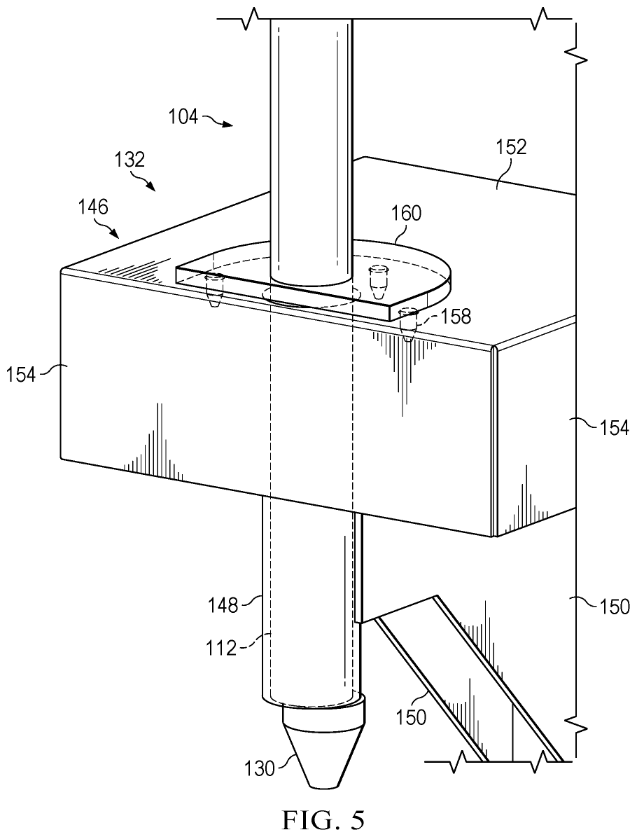

The lever 118 is located at the first end 108 and coupled to a first end of the internal rod 120, which is located within the upper shaft 114 and extends from an upper end to a lower end. The eccentric cam lock 122 is located at the second end 112 and is coupled to a second end of the internal rod 120. The lever 118 is movable from a first, open position to a second, locked position. In one embodiment, the lever 118 may be rotated 180 degrees to move from the first position to the second position. In the first, open position, shown in FIG. 4 the eccentric cam lock 122 is aligned and flush with the internal rod 120. In the second, locked position, shown in FIGS. 5 and 6, a tip 130 of the eccentric cam lock 122 is rotated and offset, which allows the locking of the upper member 104 to the lower member 106.

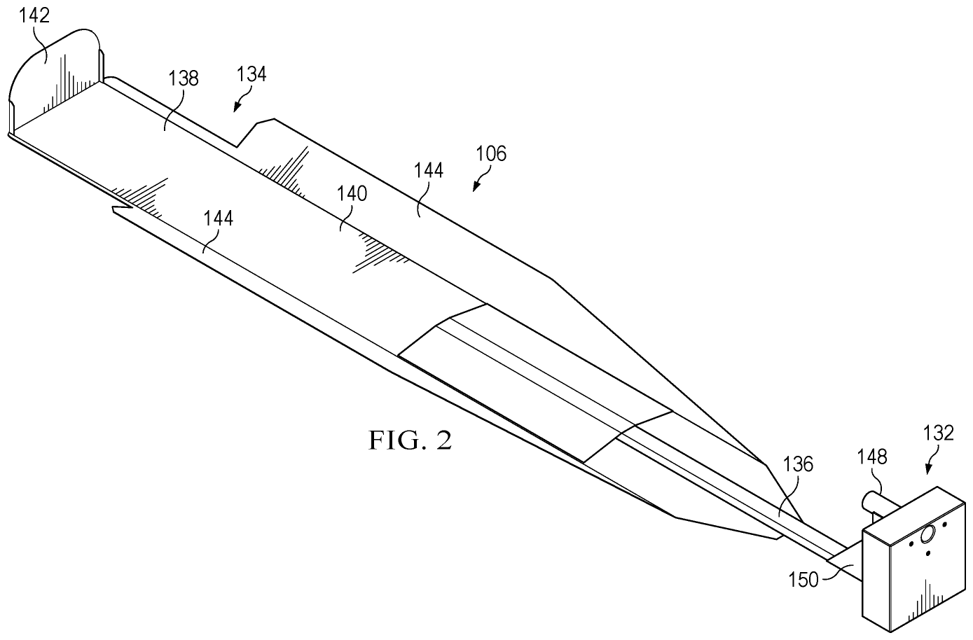

Referring now to FIG. 2, the lower member 106 may comprise an attachment point 132 and a backboard 134. The attachment point 132 may be coupled to the backboard 134 by a lower shaft 136. The backboard 134 may comprise a specimen support plate 138. The specimen support plate 138 may comprise an elongated body 140 with a lower support 142 and a pair of side supports 144, which are configured to attach the cryogenic specimen 102 to the backboard 134, as shown in FIG. 1. Nylon straps (not shown) may be used to securely attach the cryogenic specimen 102 to the backboard 134. In operation, the cryogenic specimen 102 may be placed on the backboard 134 between the lower support 142 and side supports 144 and the nylon straps may then be used to secure the specimen thereto.

Referring now to FIGS. 4-6, the attachment point 132 may comprise an attachment plate 146, a sleeve 148, and a pair of supports 150. The attachment plate 146 may comprise an upper plate 152 and sidewalls 154 that project downwardly therefrom. While the attachment plate 146 is shown as generally square, any suitable shape and configuration may be used. The pair of supports 150 are coupled to a lower surface of the attachment plate 146 and an upper portion of the lower shaft 136, which connects the attachment point 132 to the backboard 134.

As shown in FIGS. 4 and 5, the attachment plate 146 may comprise at least one aperture 156, which is configured to receive at least one projection 158 on a cam 160 located on the lower portion of the upper shaft 114. The cam 160 and at least one projection 158 when inserted in the at least one aperture 156 are used to affix the upper member 104 to the lower member 106 and serve to not allow rotation of the upper member 104 with respect to the lower member 106.

In various embodiments, the sleeve 148 is coupled to a lower portion of the upper plate 152 of the attachment plate 146. The sleeve 148 is configured to receive the tip 130 on the eccentric cam lock 122, which is located on the lower end of the internal rod 120 that resides within the upper shaft 114 of the upper member 104.

Referring again to FIGS. 4 and 5, in use, to attach the upper member 104 to the lower member 106, the eccentric cam lock 122 is inserted within the sleeve 148, and the at least one projection 158 on the cam 160 is inserted within the at least one aperture 156 on the attachment plate 146. The tip 130 may be conical to facilitate insertion within the sleeve 148. Upon insertion, the tip 130 of the eccentric cam lock 122 projects from the bottom of the sleeve 148. The user then moves the lever 118 from the first, open position to the second, locked position. As shown in FIG. 5, the rotation of the lever 118 causes the tip 130 of eccentric cam lock 122 to rotate and offset, which locks and couples the upper member 104 to the lower member 106 such that the lifting mechanism 100 is now ready for use.

The upper member 104 of the lifting mechanism 100 quickly attaches and detaches from the lower member 106, which contains the cryogenic specimen 102, even when fully submerged in liquid nitrogen. The upper member 104 may be mechanically locked to the lower member 106 while the cryogenic specimen 102 is totally submerged in liquid nitrogen. As such, the risk of exposure between a technician and the liquid nitrogen is minimized. The lock/unlock action is performed by the actuation of the lever 118 on locking mechanism 116 of the upper member 104, which is located above the liquid level and may be easily done by the user with one hand.

The handle 110 on the upper member 104 enables a technician to manually reposition the cryogenic specimen 102 within the Dewar vessel or tank, to maximize available space. The eye bolt on the lifter can be connected to a hoist to elevate and transfer the specimen rapidly.

Additionally, one upper member 104 of the lifter mechanism can be used with any lower member 106 containing the backboard 134. As such, only one upper member 104 of the lifter mechanism needs to be constructed for any number of lower members 106 containing the backboard 134. The cryogenically specimen 102 may be left attached to the lower member 106 containing the backboard 134 permanently once they have been placed into the Dewar vessel or other type of cryogenic storage chamber for long-term storage.

The backboard 134 may be contoured to the profile of a human body so it can be securely fastened to the cryogenic specimen 102, with as few protrusions or snag points along its outside. This ensures it can be inserted into the Dewar vessel or other type of cryogenic storage chamber alongside other specimens without risk of catching on them. The lifting mechanism 100 may be made of strong enough materials to hold a minimum of 4001b max load.

The lifting mechanism 100 may be constructed from aluminum because its high strength to weight ratio enables the user to manipulate the specimen without undue stress. The aluminum material also allows the user to easily carry the lifting mechanism 100 when the cryogenic specimen 102 is not attached. It should be understood that any suitable material may be used to construct the lifting mechanism 100 as long as material is light, compatible with cryogenic liquids and sufficiently strong to hold up to 400 lbs when loaded axially in tension and can withstand the conditions of the Dewar vessel or other type of cryogenic storage chamber containing liquid nitrogen and a cryogenic specimen 102. Some other types of suitable material may comprise steel, bronze, titanium, glass, carbon composites and the like.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to an exemplary embodiment. However, changes and modifications may be made to the exemplary embodiment without departing from the scope of the present technology. These and other changes or modifications are intended to be included within the scope of the present technology.

1. A lifting mechanism for a placement of a cryogenic specimen in a cryogenic storage chamber or Dewar vessel, the lifting mechanism comprising:
an upper member comprising:
a handle,
an upper shaft coupled to the handle at a first end, and
a locking mechanism, and
a lower member coupled at a second end of the upper shaft comprising:
an attachment point,
a backboard coupled to the attachment point by a lower shaft and configured to support the cryogenic specimen.

2. The lifting mechanism of claim 1, wherein the locking mechanism comprises:
a lever coupled to the upper shaft at the first end of the upper shaft;
an internal rod coupled to the lever at a first end and received within the upper shaft; and
an eccentric cam lock coupled to a second end of the internal rod.

3. The lifting mechanism of claim 2, wherein the attachment point comprises a sleeve configured to receive the eccentric cam lock.

4. The lifting mechanism of claim 3, wherein the eccentric cam lock comprises a tip, which projects outwardly from a lower end of the sleeve when the upper member is coupled to the lower member.

5. The lifting mechanism of claim 4, wherein the lever rotates the eccentric cam lock from a first position to a second position to couple the upper member to the lower member.

6. The lifting mechanism of claim 5, wherein upon rotation of the lever the eccentric cam lock rotates and offsets to couple the upper member to the lower member.

7. The lifting mechanism of claim 3, wherein the attachment point includes an attachment plate with at least one aperture.

8. The lifting mechanism of claim 7, wherein the upper shaft comprises a cam located proximate to the second end, wherein the cam comprises at least one projection to be received within the at least one aperture when the upper member is coupled to the lower member.

9. The lifting mechanism of claim 8, wherein the attachment plate comprises multiple apertures and the cam comprises the same amount of projections, which are received within the multiple apertures when the upper member is coupled to the lower member.

10. The lifting mechanism of claim 1, wherein the upper member further comprises a hoist point.

11. The lifting mechanism of claim 1, wherein the handle comprises a pair of arms that extend outwardly from the attachment location of the handle to the upper end of the upper shaft.

12. The lifting mechanism of claim 1, wherein the backboard further comprises a specimen support plate having an elongated body with a lower support and a pair of side supports that are configured to attach the cryogenic specimen to the backboard.

13. The lifting mechanism of claim 1, wherein the cryogenic specimen is coupled to the backboard by straps.

14. A lifting mechanism for a placement of a cryogenic specimen in a cryogenic storage chamber or Dewar vessel, the lifting mechanism comprising:
an upper member comprising:
a handle,
an upper shaft coupled to the handle at a first end, and
a locking mechanism, and
a lower member coupled at a second end of the upper shaft comprising:
an attachment point comprising a sleeve configured to receive the locking mechanism to couple the lower member to the upper member,
a backboard coupled to the attachment point and configured to support the cryogenic specimen.

15. The lifting mechanism of claim 14, wherein the locking mechanism comprises:
a lever coupled to the upper shaft at the first end;
an internal rod coupled to the lever at a first end and received within the upper shaft; and
an eccentric cam lock coupled to a second end of the internal rod.

16. The lifting mechanism of claim 15, wherein the eccentric cam lock comprises a tip, which projects outwardly from a lower end of the sleeve when the upper member is coupled to the lower member.

17. The lifting mechanism of claim 16, wherein the lever rotates the eccentric cam lock from a first position to a second position to couple the upper member to the lower member.

18. The lifting mechanism of claim 17, wherein upon rotation of the lever the eccentric cam lock rotates and offsets to couple the upper member to the lower member.
